(19) United States
(12) Patent Application Publication
(10) Pub. No.: US 2025/0096367 A1
(43) Pub. Date: Mar. 20, 2025

(54) BARRIER ARTICLE FOR A RECHARGEABLE ELECTRICAL ENERGY STORAGE SYSTEM

(71) Applicant: 3M INNOVATIVE PROPERTIES COMPANY, St. Paul, MN (US)

(72) Inventors: Walter R. Romanko, Austin, TX (US); Morgan A. Priolo, Georgetown, TX (US); Maximilian Ohligs, Neuss (DE); Mathis A. Muth, Muelheim an der Ruhr (DE); Christoph Kuesters, Korschenbroich (DE); Mitchell T. Huang, Austin, TX (US); Mark A. Fairbanks, Lino Lakes, MN (US); Daniel S. Bates, Chisago City, MN (US); Marcus Kucharz, Oberasbach (DE); Juergen Schnusenberg, Willich (DE); Harald Gruber, Purgstall/E. (AT); Junkang J. Liu, Woodbury, MN (US)

(21) Appl. No.: 18/832,762

(22) PCT Filed: Jan. 30, 2023
(86) PCT No.: PCT/IB2023/050786

§ 371 Date: Jul. 24, 2024

Related U.S. Application Data
(60) Provisional application No. 63/375,780, filed on Sep. 15, 2022.
(60) Provisional application No. 63/267,354, filed on Jan. 31, 2022.

(51) Int. Cl. H01M 10/658; B32B 5/02; B32B 5/26; B32B 37/12; H01M 10/625; H01M 10/651; H01M 50/131

(52) U.S. Cl. CPC H01M 10/658; B32B 5/022; B32B 5/024; B32B 5/26; B32B 37/1284; H01M 10/625; H01M 10/651; H01M 50/131; B32B 2250/20; B32B 2262/101

(57) ABSTRACT

A barrier article comprises a multilayer article that includes a plurality of core layers and a plurality of binder layers, wherein at least one core layer includes a woven or nonwoven fiber mat or fabric, and wherein at least one binder layer includes a silicone material. The plurality of core layers and binder layers are arranged in an alternating manner. The barrier article is operatively adapted to survive or withstand at least seven cycles of the Torch and Grit Test. The barrier article can be flexible and can provide a thermal insulation and blast protection barrier in, for example, a rechargeable electrical energy storage system.

### CROSS-REFERENCE TO RELATED APPLICATIONS

This application claims the benefit of U.S. Provisional Application No. 63/267,354, filed Jan. 31, 2022; and U.S. Provisional Application No. 63/375,780, filed Sep. 15, 2022, the disclosures of which are incorporated by reference in their entirety herein.

### FIELD

The invention relates to the use of a multilayer material as a barrier article in a rechargeable electrical energy storage system comprising for example a plurality of single rechargeable battery cells or battery cell modules or battery cell module packs.

The present invention also relates to electric vehicle batteries and particularly to blast resistant and thermally insulating barrier articles for managing battery cell/module/pack thermal runaway incidents. The provided articles can be especially useful, for example, in automotive, aircraft, watercraft, and stationary energy storage applications.

### BACKGROUND

Rechargeable or reloadable batteries or rechargeable electrical energy storage systems comprising a number of single battery cells, such as for example lithium-ion cells, are known and used in several fields of technique, including e.g., as electric power supply of mobile phones and portable computers or electric cars or vehicles or hybrid cars.

It is also known that rechargeable battery cells, such as lithium-ion cells, sometimes undergo internal overheating caused by events such as short circuits within the cell, improper cell use, manufacturing defects or exposure to extreme external temperature. This internal overheating can lead to a so called “thermal runaway” when the reaction rate within the cell caused by the high temperature increases to a point where more heat is generated within the cell than can be withdrawn and the generated heat leads to a further increase of the reaction rate and in turn of the generated heat. In standard lithium-ion (Li-ion) battery configurations, for example, the heat generated within such defective cells can reach 500° C. to 1000° C., in localized hot spots even more.

The next generation of electrical vehicle EV batteries will have higher energy than batteries used today. High energy batteries such as those described as 811 (NMC, or nickel-manganese-cobalt ratio) or similar energy density can fail catastrophically if punctured or overheated. When this occurs, the ensuing battery fire will not only reach temperatures of 1200° C. or above but may also expel shrapnel at moderately high velocities. While battery packs are generally encased in an aluminum shell, aluminum melts at 660° C., so the shell must be protected from the flame and shrapnel of a failed battery to allow occupants of the electrical vehicle time to exit in the event of such a failure. Battery packs can also be encased in fiber-reinforced polymeric composites, which, like aluminum, can also be breached at elevated temperatures.

While some materials exist that can survive a high temperature flame (i.e., greater than 1200° C. flame for tens of minutes with no breach), these materials cannot withstand the blast associated with a high energy battery thermal runaway event. Severe risks posed by thermal runaway propagation requires design of the battery module that features blast resistant and thermally insulating barriers to mitigate the effects of such a thermal runaway and provide time for vehicle occupants to safely vacate in the event of a fire.

PCT Patent Publication WO 2021/144758, incorporated by reference herein in its entirety, describes thermal barrier articles and a Torch and Grit Test useful for determining thermal runaway and blast resistance properties.

### SUMMARY OF THE INVENTION

In view of the above, there is still a need for suitable materials and suitable arrangements that help to provide thermal insulation and that help to prevent or mitigate damage to adjacent materials and regions from blast particles emanating from a malfunctioning battery pack. There is also a need for such suitable materials that are easy to use in an assembly process and that provide flexibility with designing a rechargeable electrical energy storage system.

The present invention provides a barrier article comprising a multilayer material. The multilayer material includes an alternating arrangement of a plurality of core layers and a plurality of binder layers.

In a first aspect, at least one core layer includes a woven or nonwoven fiber mat or fabric, wherein the woven or non-woven fibrous mat or fabric comprises inorganic fibers.

In another aspect, at least one binder layer includes a silicone material. The silicone material can comprise a silicone polymer and may include one or more filler materials or additives.

In another aspect, the core layers of the multilayer material can be the same throughout the multilayer material. In another aspect, the core layers of the multilayer material can comprise different materials in some or all of the plurality of core layers.

In another aspect, the binder layers of the multilayer material can be the same throughout the multilayer material. In another aspect, the binder layers of the multilayer material can comprise different materials in some or all of the plurality of binder layers.

In another aspect, the plurality of core layers comprises at least three core layers.

In another aspect, the plurality of binder layers comprises at least two binder layers.

In another aspect, a core layer comprises a woven or nonwoven fiber mat or fabric comprising a plurality of fibers selected from the group consisting of A-glass, C-glass, D-glass, E-glass, M-glass, R-glass, S-glass, ECR-glass, AR-glass, basalt fibers, silicate fibers (e.g. Astroquartz fibers), silicon carbide fibers, ceramic fibers (e.g. Nextel fibers), or other inorganic fibers.

In another aspect, the thermal barrier article is operatively adapted to survive or withstand at least seven cycles or blasts of the torch and grit test (T&GT). In addition, the thermal barrier article has a ratio of T&GT blasts withstood divided by sample thickness of at least 4.4. In another example, the thermal barrier article has a ratio of T&GT blasts withstood divided by sample thickness of at least 4.6.

In another aspect, the thermal barrier article is flexible such that it can bend at least 0.5% in a 3 point bend test (per ASTM D790) before failing.

In another aspect, the present invention provides a battery compartment of an electric vehicle comprising at least one battery cell or assembly and the thermal barrier article described above.

In another aspect, a method of preventing or at least mitigating the further spread of blast debris in or from an electric vehicle battery assembly comprises providing at least one battery cell of an electric vehicle battery assembly with the thermal barrier article described above.

Protecting against the dangers associated with a sudden thermal runaway event in an electric vehicle battery is a significant technical challenge.

Embodiments of the present invention address the challenges with conventional materials by providing a blast and thermal resistant barrier article that combines a plurality of core layers and a plurality of binder layers in an alternating arrangement, with at least one core layer containing a woven or non-woven fibrous mat or fabric comprising inorganic fibers and with each binder layer comprising a silicone material. The core and binder layers create a blast and thermal barrier article that is operatively adapted to survive or withstand at least one cycle of the Torch and Grit Test. In electric vehicle battery applications, the combination of the designated core and binder layers can provide blast protection and a high degree of thermal insulation in the event of fire exposure.

### BRIEF DESCRIPTION OF THE DRAWINGS

The invention will now be described in more detail with reference to the following figures exemplifying particular embodiments of the invention:

FIG. 1 is a schematic cross section view of a barrier article according to an aspect of the invention.

FIG. 2 is a schematic view of an exemplary battery compartment of an electric vehicle.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definition(s)

As used herein:
“thickness” means the distance between opposing sides of a layer or barrier article.
“flexible” means that a material is non-brittle and can bend at least 0.5% in a 3-point bend test (per ASTM D790) before failing.

### DETAILED DESCRIPTION

As used herein, the term “operatively adapted” refers to a structure that is designed, configured and/or dimensioned to perform the identified operation or performance.

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises”, and variations thereof, do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, and vertical may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

According to an embodiment of the invention, a barrier article comprises a multilayer material. The multilayer material includes an alternating arrangement of a plurality of core layers (A) and a plurality of binder layers (B) (e.g., A/B/A/B/A/B). In a first aspect, at least one core layer comprises a woven or non-woven fibrous mat or fabric, where the woven or non-woven fibrous mat or fabric comprises inorganic fibers. In addition, at least one binder layer comprises a silicone material. The silicone material can comprise a silicone polymer and may further include one or more filler materials or additives.

The multilayer material according to the invention may for example be used to ensure the overall safety of vehicles equipped with a rechargeable electrical energy storage system. The multilayer material may comprise at least four layers in an alternating material composition. When applied in an electric or hybrid vehicle, the alternating materials should have a suitable total thickness to accommodate a potentially constrained deployment space, while still providing sufficient thermal properties and blast resistance.

To more safely enclose a battery pack in the event of a thermal runaway, the lid of a battery housing should be protected from the flame and shrapnel of a failed battery with a flame and blast-resistant lining, sometimes referred to as an “under-lid” material.

A suitable material used as a thermal insulation barrier should withstand high temperatures and high pressures accompanied by gas venting and particle blow without getting too damaged. In addition, the material needs to provide thermal and electrical insulation properties even during and after the high temperature, pressure and gas and/or particle impact.

The multilayer material according to the invention may be flexible. By “flexible” it is meant that the material is non-brittle and can bend at least 0.5% in a 3 point bend test (per ASTM D790) before failing. Flexibility of the multilayer material enables a broader use of the material and a more effective application of the material because the flexibility allows bending of the material and therefore more options of applying it within a rechargeable electrical energy storage system.

The multilayer material according to the invention may comprise an inorganic fabric which comprises A-glass, C-glass, D-glass, E-glass, M-glass, R-glass, S-glass, ECR-glass, AR-glass, basalt fibers, silicate fibers (Astroquartz fibers), silicon carbide fibers, ceramic fibers (e.g. Nextel fibers), other inorganic fibers or a combination thereof. The fibers may be chemically treated. The inorganic fabric may for example be a single layer cloth, knitted fabric, interlaced fabric, and crocheted fabric or multilayer fabrics comprising woven or nonwoven layers bonded together by stitching, mechanical entanglement, or inorganic adhesives, or a combination thereof.

In another embodiment, while one core layer may include a woven or non-woven mat of fibrous material, as described above, another of the core layers may include inorganic particles or inorganic fibers such as an inorganic paper or an inorganic board. This layer may for example comprise an inorganic insulating paper comprising glass fibers and microfibers, such as 3M CEQUIN, commercially available from 3M Company, St. Paul, Minn., USA.

Each core layer may for example comprise a thickness in the range of 0.04 to 1.5 mm, for example 0.1 to 0.6 mm. It may also comprise a weight of 35 to 1,500 g/m² (gsm). The diameter of the individual filaments may range from about 4 to about 13 microns. The number of filaments per yarn can vary from about 5 to 1000. Typical weave patterns can include plain, basket, twill, leno, four-harness satin, eight-harness satin, and others typical in the industry. The warp and weft yarns can be the same or of different make-up.

In some embodiments, the binder layer comprises a silicone material and one or more fillers or additives. For example, the fillers can include inorganic materials such as glass, ceramic, clay, silicate, mineral, flame retardant agent, smoke suppression agent, endothermic agent, rheology modifier, and the combination thereof. The form of the filler can include bead, solid particle, ground powder, flake, needle, rod, chopped fiber, hollow sphere, hollow tube, and the combination thereof.

The examples of clay or aluminosilicate include, but are not limited to: kaolin clay, talc, mica, wollastonite, montmorillonite, smectite, bentonite, illite, chlorite, sepiolite, attapulgite, halloysite, laponite, rectorite, perlite, and combinations thereof. Suitable types of kaolin clay include, but are not limited to, water-washed kaolin clay, delaminated kaolin clay, calcined kaolin clay, and surface-treated kaolin clay.

The examples of minerals include, but not limited to calcite, aragonite, limestone, quartz, sphalerite, colemanite, ferberite, fluorite, gypsum, rutile, and apatite.

In one preferred embodiment, the inorganic particulate filler comprises glass beads, calcined kaolin clay, and mixtures thereof.

Optionally, a flame retardant additive, a smoke suppression additive, a rheology modifier, an endothermic filler, and the mixtures thereof, such as alumina trihydrate, magnesium hydroxide, polyphosphate, and silicone tackifier resin, can be added. The total thickness of the multilayer material may be between 0.5 and 23 mm. In some applications where thinner materials are used, the total thickness of the multilayer material may be between 0.7 and 5 mm. It is possible to adjust the thickness of the material depending on the application the material is used in. As already stated above, the material may be flexible to improve the ease of applying the material in an assembly process, and to aid in withstanding shock and vibration in an automotive or other environment.

The at least one binder layer may comprise a silicone-based material, such as a layer of a silicone-based adhesive, a contact adhesive, pressure sensitive adhesive (PSA), B-stageable adhesive or structural adhesives. In one preferred embodiment, the at least one binder layer comprises silicone-based materials. The silicone-based material can be crosslinked via condensation, addition, peroxide, or high energy radiation (e.g., e-beam or gamma) cure.

In another embodiment, one or more silicone-based material layers can further comprise combinations of the silicone units M, D, T, and Q. The silicone-based material layers can comprise silicone resins (e.g., MQ or TQ resins), particularly resins with a low M content.

In one embodiment, the binder layer comprises a silicone PSA (crosslinked silicone comprising tackifier resins).

In another embodiment, the binder layer comprises 100% silicone (e.g., polydimethylsiloxane, polydiphenylsiloxane).

In another embodiment, the binder layer comprises a silicone-MQ blend, with 40% or less silicone MQ.

In another embodiment, the binder layer comprises a silicone-MQ blend, with 60% or more silicone MQ.

In another embodiment, the binder layer comprises a silicone-MQ blend of about 50% MQ in silicone polymer.

In another embodiment, at least one of the plurality of binder layers can comprise a blend of silicone with inorganic clays and minerals such as kaolin, metakaolin, calcined kaolin, talc, mica, mullite, phlogopite, muscovite, montmorillonite, smectite, bentonite, illite, chlorite, sepiolite, attapulgite, halloysite, vermiculite, laponite, rectorite, perlite, fly ash, fumed silica, silica fume, quartz, titanium dioxide, boron nitride, iron oxide, and other inorganic materials.

In another embodiment, at least one of the plurality of binder layers can comprise a filler material comprising solid glass particles. The solid glass particles may comprise one or more of glass beads, glass flakes, chopped glass fibers, glass shards, and ground glass powders. These solid glass particles can have an average size of about 2 to about 300 microns. In another embodiment, the solid glass particles can have an average size of about 10 to about 100 microns. In another embodiment, the solid glass particles can have an average size of about 10 to about 80 microns. In another embodiment, the solid glass particles can have an average size of about 10 to about 60 microns. The range of sizes of these particles may be relatively monodisperse, or the particles may have a broad distribution of particle sizes. It may be advantageous to use a bi- or tri-modal distribution of particle sizes to increase filler loading. In the case of high aspect ratio glass particles such as glass flakes or chopped glass fibers, the average size of the largest dimension can be from about 1 mm to about 8 mm.

In another embodiment, at least one of the plurality of binder layers can comprise carbon black.

In another embodiment, at least one of the plurality of binder layers can further comprise chopped inorganic fibers.

As is apparent given the description herein, each of the plurality of binder layers can have the same or different compositions, and/or can have the same or different thicknesses.

The binder layers/adhesives can be directly coated onto one of the core layers and optionally dried or can be preformed into freestanding lamination film adhesives that can be applied to the surface of one of the core layers prior to contacting the next core layer. In an alternative aspect, one or more of the core layers can be in the form of a tape having an adhesive layer (e.g., a pressure sensitive adhesive layer) already disposed on the core layer material.

In one preferred embodiment, at least two core layers comprise a woven or nonwoven glass fiber mat or fabric, and wherein at least two binder layers comprise silicone with an inorganic filler.

In one preferred embodiment, at least two core layers each comprise a woven or nonwoven glass fiber mat or fabric, and wherein at least one binder layer can comprise silicone with an inorganic filler and another binder layer can comprise a PSA.

In one preferred embodiment, at least four core layers each comprise a woven or nonwoven glass fiber mat or fabric, and wherein at least four binder layers comprise silicone with an inorganic filler.

In one preferred embodiment, at least four core layers each comprise a woven or nonwoven glass fiber mat or fabric, and wherein at least three binder layers each comprise silicone with an inorganic filler and another binder layer comprises a PSA.

In one preferred embodiment, at least two core layers each comprise a woven or nonwoven glass fiber mat or fabric, and wherein at least two binder layers each comprise silicone with MQ resin.

In one preferred embodiment, at least two core layers each comprise a woven or nonwoven glass fiber mat or fabric, and wherein at least two binder layers each comprise silicone with MQ resin and another binder layer comprises a PSA.

In one preferred embodiment, at least four core layers each comprise a woven or nonwoven glass fiber mat or fabric, and wherein at least four binder layers each comprise silicone with MQ resin.

In one preferred embodiment, at least four core layers each comprise a woven or nonwoven glass fiber mat or fabric, and wherein at least three binder layers each comprise silicone with MQ resin and another binder layer comprises a PSA.

In one preferred embodiment, at least four core layers each comprise a woven or nonwoven glass fiber mat or fabric, and wherein at least three binder layers each comprise silicone with an inorganic filler.

In one preferred embodiment, at least four core layers each comprise a woven or nonwoven glass fiber mat or fabric, and wherein at least three binder layers each comprise silicone with MQ resin.

In one preferred embodiment, at least two core layers each comprise a woven or nonwoven glass fiber mat or fabric, and wherein at least one binder layer comprises a silicone pressure sensitive adhesive and one binder layer comprises a blend of silicone and glass beads.

An embodiment of the invention also relates to a rechargeable electrical energy storage system with at least one battery cell and a barrier article such as described above.

An embodiment of the multilayer material according to the invention may for example be used to as a barrier article that helps increase the overall safety of vehicles equipped with a rechargeable electrical energy storage system.

The multilayer material may be arranged in a rechargeable electrical energy storage system such that a core layer faces the at least one battery cell/pack/module. The core layer is selected such that it has a high resistance towards temperature and other impacts, as might occur during a thermal runaway event.

The rechargeable electrical energy storage system according to the invention may provide a barrier article which is positioned between the at least one battery cell and a lid of the storage system. The barrier article may for example be fixed to the lid. Or it may be placed between the battery cells and the lid. The barrier article may in such a position be used as a thermal insulation barrier for the lid or to protect the lid and any systems or components that are arranged adjacent to the lid. It may also be used as a thermal insulation barrier for any electrical components around the battery cells or battery packs such as for example cables or bus bars. When the barrier article provides in addition electrically insulating properties, short circuits for example due to deformation or other harm, e.g., heated electrical insulation around different battery systems, can also be mitigated/prevented. Another possibility is to arrange the barrier article such that it covers a burst plate of the at least one battery cell. Of course, the barrier article can also be positioned in a rechargeable electrical energy storage system such that it fulfills all of the above-mentioned requirements. As already stated above, it might be advantageous to position the barrier article according to the invention such that the core layer faces towards the at least one battery cell, and, in particular, the core layer faces towards the burst plate of the battery cell.

Also, the use of the barrier article according to the invention is not limited to the use in a specific kind of rechargeable electrical energy storage systems. It may, for example, be used in rechargeable electrical energy storage system comprising prismatic battery cells, pouch cells, or cylindrical cells.

Also, the use of the barrier article according to the invention is not limited to the use in a specific kind of vehicle.

Herein below various embodiments of the present invention are described and shown in the drawings wherein like elements are provided with the same reference numbers.

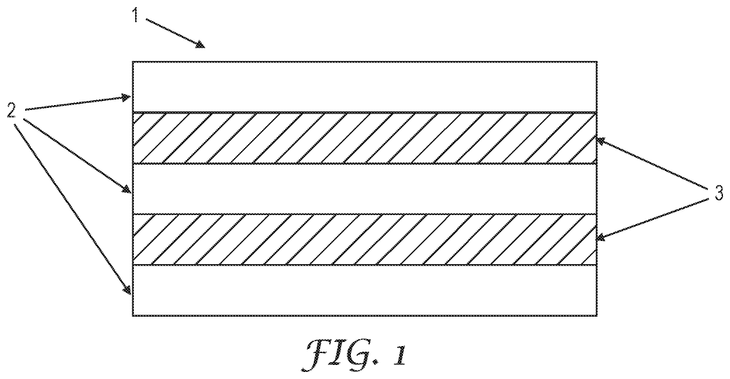

In FIG. 1 a cross-sectional view of a barrier article 1 according to the invention is displayed. The barrier article of FIG. 1 comprises a plurality of core layers 2 and a plurality of binder layers 3. In this example, barrier article 1 comprises three core layers 2 and two binder layers 3. In other embodiments the barrier article can comprise alternating layers of 2, 4, 5, 6, 7, 8, 9, 10 (or more) core layers with 2, 3, 4, 5, 6, 7, 8, 9 (or more) binder layers.

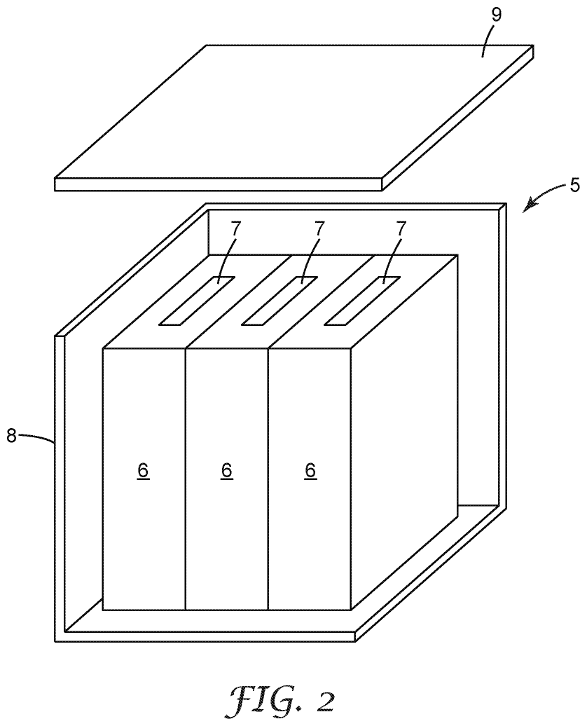

FIG. 2 is a schematic drawing of a rechargeable electrical energy storage system 5. The system comprises prismatic battery cells 6. The prismatic battery cells 6 each comprise a burst plate 7 to release potentially generated excessive pressure through a venting hole, for example in case of a thermal runaway event. The cells 6 are arranged in a housing 8 (which is shown with two open walls-one front wall and one side wall—that are closed in reality). The housing provides a lid 9.

As already described above regulations require that a rechargeable energy storage system is to be built in a way that no external fire occurs. One area that needs to be protected is the area above the burst plates 7. Parts of the system that are arranged over the burst plate need a thermal barrier in order to avoid a burn-through of the battery and open flames outside of the system. According to the invention the barrier article 1 shown in FIG. 1 is disposed between battery cells 6/burst plates 7 and the lid 9.

The multilayer material 1 may also be placed between the cells 6 and the side walls or the bottom wall of the housing 8 (not shown).

The blast resistant and thermally insulating barrier articles described herein, in some embodiments, can be effective in mitigating the effects of thermal runaway propagation in Li-Ion batteries. These articles can also have potential uses in other commercial and industrial applications, such as automotive, residential, industrial, watercraft, and aerospace applications, where it is necessary to protect people or surrounding structures from the effects of flying debris or thermal fluctuations. For example, the blast resistant and thermally insulating barrier articles can be incorporated into primary structures extending along or around transportation or building compartmental structures to protect users and occupants. Such applications can include protection around battery modules, fuel tanks, and any other enclosures or compartments.

Further components, configurations thereof, and test methods are described in the sub-sections that follow.

Further, the particle size of the inorganic filler particles in the binder layer may only be limited by binder layer thickness. Typically, the inorganic filler particles have a maximum particle size of about 8000 microns (μm) in at least one dimension. More typically, the inorganic filler particles have a particle size ranging from about 0.1 μm to about 2000 μm in at least one dimension. Even more typically, the inorganic filler particles have a particle size ranging from about 0.2 μm to about 50 μm in at least one dimension.

These layers, and successive layers, are shown flatly contacting each other in FIG. 1. However, it is to be understood that the layers of the barrier article 1 are flexible and the contacting areas between layers may not be planar or even continuous.

The barrier article 1 of FIG. 1 can be disposed in one or more locations in an electric vehicle battery module. Typically, a plurality of battery cells is structurally aligned and secured within a battery compartment. The battery cells can be any shape (e.g., cylindrical or rectangular) or size. Gaps are generally present between each of the battery cells and/or between the battery cells and the walls of the battery compartment. The barrier articles can be secured to the compartment lid or disposed on the walls of the battery compartment.

### Exemplary Embodiments

1. A thermal barrier article comprising:
a plurality of core layers, wherein at least one core layer includes a woven or nonwoven fiber mat or fabric; and
a plurality of binder layers, wherein at least one binder layer includes a silicone material, wherein the plurality of core layers and binder layers are arranged in an alternating manner, and
wherein the thermal barrier article is operatively adapted to survive or withstand at least seven cycles of the torch and grit test (T&GT).

2. The thermal barrier article of embodiment 1, wherein the woven or nonwoven fiber mat or fabric comprises a plurality of inorganic fibers.

3. The thermal barrier article of any of embodiments 1-2, wherein the woven or nonwoven fiber mat or fabric comprises a plurality of fibers selected from the group consisting of A-glass, C-glass, D-glass, E-glass, M-glass, R-glass, S-glass, ECR-glass, AR-glass, basalt fibers, silicate fibers (e.g. Astroquartz fibers), silicon carbide fibers, ceramic fibers (e.g. Nexctel fibers), or combinations thereof.

4. The thermal barrier article of any one of embodiments 1 to 3, wherein the plurality of binder layers each comprise a silicone polymer.

5. The thermal barrier article of embodiment 4, wherein the silicone polymer further comprises a filler material or additive.

6. The thermal barrier article of any of embodiments 1-5, wherein the thermal barrier article has a thickness in the range of from about 0.5 mm to about 10.0 mm.

7. The thermal barrier article of any of embodiments 1-6, comprising at least three core layers and at least two binder layers.

8. The thermal barrier article of any of embodiments 1-7, wherein each of the plurality of core layers comprises the same material.

9 The thermal barrier article of any of embodiments 1-8, wherein at least two of the plurality of core layers comprises different materials.

10. The thermal barrier article of any of embodiments 1-9, wherein at least two of the plurality of binder layers comprises different materials.

11. The thermal barrier article of any of embodiments 1-10, comprising at least four core layers and at least three binder layers.

12. The thermal barrier article of any of embodiments 1-11, wherein each core layer comprises a thickness from about 0.04 mm to about 1 mm.

13. The thermal barrier article of any of embodiments 1-12, wherein each core layer comprises a thickness from about 0.1 mm to about 0.6 mm.

14. The thermal barrier article of any of embodiments 1-13, wherein at least one binder layer comprises a solid glass particle filler material.

15. The thermal barrier article of any of embodiments 1-14, wherein the solid glass particle filler material has an average size of about 10 microns to about 60 microns.

16. The thermal barrier article of any of embodiments 1-15, wherein the thermal barrier article has a ratio of T&GT blasts withstood over sample thickness of at least 4.4.

17. The thermal barrier article of any of embodiments 1-5, wherein the thermal barrier article is operatively adapted to have a surviving blast number to overall thickness ratio of at least 6.5.

18. The thermal barrier article of any of the preceding embodiments, wherein the barrier article is flexible such that it can bend at least 0.5% in a 3 point bend test (per ASTM D790) before failing.

19. A battery compartment of an electric vehicle comprising at least one battery cell or assembly, wherein the thermal barrier article of any one of embodiments 1 to 18 is disposed between the at least one battery cell or assembly and a lid.

20. A method of preventing or at least mitigating the further spread of blast debris in or from an electric vehicle battery assembly, with the method comprising:
at least partially enclosing at least one battery cell or module of an electric vehicle battery assembly with the thermal barrier article of any one of embodiments 1 to 18.

21. Use of a barrier article as a thermal insulation and blast protection barrier in a rechargeable electrical energy storage system, the barrier article comprising a multilayer article that includes:
a plurality of core layers, wherein at least one core layer includes a woven or nonwoven fiber mat or fabric, and
a plurality of binder layers, wherein at least one binder layer includes a silicone material, wherein the plurality of core layers and binder layers are arranged in an alternating manner, and
wherein the thermal barrier article is operatively adapted to survive or withstand at least seven cycles of the torch and grit test (T&GT).

22. Use of a barrier article according to embodiment 21, wherein the woven or nonwoven fiber mat or fabric comprises a plurality of inorganic fibers.

23. Use of a barrier article according to any of embodiments 21-22, wherein the woven or nonwoven fiber mat or fabric comprises a plurality of fibers selected from the group consisting of A-glass, C-glass, D-glass, E-glass, M-glass, R-glass, S-glass, ECR-glass, AR-glass, basalt fibers, silicate fibers, silicon carbide fibers, ceramic fibers (e.g. Nextel fibers), or combinations thereof.

24. Use of a barrier article according to embodiments 21-23, wherein the plurality of binder layers each comprise a silicone polymer.

25. Use of a barrier article according to any of embodiments 21-24, wherein the silicone polymer further comprises a filler material or additive.

26. Use of a barrier article according to any of embodiments 21-25, wherein at least one binder layer comprises a solid glass particle filler material.

27. Use of a barrier article according to any of embodiments 21-26, wherein the solid glass particle filler material has an average size of about 10 microns to about 60 microns.

28. Use of a barrier article according to any of embodiments 21-27, wherein the thermal barrier article has a ratio of T&GT blasts withstood divided by sample thickness of at least 4.4.

29. Use of a barrier article according to any of embodiments 21-28, wherein the thermal barrier article has a thickness in the range of from about 0.5 mm to about 10.0 mm.

30. Use of a barrier article according to any of embodiments 21-29, comprising at least three core layers and at least two binder layers.

31. Use of a barrier article according to any of embodiments 21-30, wherein each of the plurality of core layers comprises the same material.

32. Use of a barrier article according to any of embodiments 21-31, wherein at least two of the plurality of core layers comprise different materials.

33. Use of a barrier article according to any of embodiments 21-32, wherein at least two of the plurality of binder layers comprise different materials.

34. Use of a barrier article according to any of embodiments 21-22, comprising at least four core layers and at least three binder layers.

35. Use of a barrier article of any of embodiments 21-34, wherein the barrier article is flexible such that it can bend at least 0.5% in a 3 point bend test (per ASTM D790) before failing.

### EXPERIMENTS AND EXAMPLES

TABLE 1
Test Materials

| Material | Description |
|---|---|
| 3M ™ Adhesive Transfer Tape 91022 (3M Co., | Silicone pressure sensitive adhesive transfer tape, |
| mmm.com) | 0.05 mm thick |
| 69 Tape (3M, 3m.com) | glass cloth electrical tape, 0.127 mm thick glass cloth |
| | backing, silicone adhesive, 0.178 mm total thickness |
| 79 Tape (3M, 3m.com) | glass cloth electrical tape, 0.127 mm thick glass cloth |
| | backing, acrylic adhesive, 0.178 mm total thickness |
| AK 1000000 (Wacker, wacker.com) | 100% polydimethylsiloxane, methyl-terminated |
| Aluminum sheet/plate | 5052 aluminum, 1.27 mm thick |
| Burgess KE (Burgess Pigment Company, | Surface-modified calcined aluminum silicate |
| burgesspigment.com) | |
| DDCBP-50 (Akrochem Corp, akrochem.com) | 50% di-(2,4-dichlorobenzoyl peroxide) in silicone |
| | fluid |
| E-glass (JPS Composite Materials, jpscm.com) | e-glass cloth, 0.06 mm thick, 56 g/sqm |
| | e-glass cloth, 0.14 mm thick, 137 g/sqm |
| | e-glass cloth, 0.61 mm thick, 874 g/sqm |
| Flat Black Automotive High Heat Paint (Rust- | Flat Black Automotive High Heat Paint, silicone- |
| Oleum, rustoleum.com) | based spray paint for heat up to 2000° F. (1093° C.) |
| FR CROS 486 (Budenheim, budenheim.com) | ammonium polyphosphate, silane coated |
| KaMin 70 C. (KaMin LLC, kaminllc.com) | calcined kaolin |
| Mattex Pro (BASF, basf.com) | calcined kaolin |
| Satintone SP33 (BASF, basf.com) | calcined kaolin |
| Silastic HV 1510-40 (Dow, dow.com) | parts A and B addition curing silicone rubber, |
| | contains fumed silica filler |
| Silicone foam | 3.5 mm thick silicone foam prepared according to |
| | WO2021/176372 |
| Silopren Electro 242-3 (Momentive Performance | silicone elastomer, two-part 1:1 mix ratio, contains |
| Materials, Inc., momentive.com) | fumed silica filler |
| Spheriglass 3000 (Potters Industries, | glass beads, 35 micron average diameter (see |
| pottersindustries.com) | Spheriglass 3000 data sheet for particle size |
| | distribution) |
| Spheriglass 3000 CP-01 (Potters Industries, | glass beads, 35 micron average diameter (see |
| pottersindustries.com) | Spheriglass 3000 data sheet for particle size |
| | distribution), silane treated |
| Suzorite ® 20-S (Imerys S.A., imerys.com) | phlogopite mica |
| Sylgard 182 (The Dow Chemical Co., | silicone elastomer, two-part 10:1 mix ratio, contains |
| sylgard.com) | dimethylvinylated and trimethylated silica |
| Sylgard 184 (The Dow Chemical Co., | silicone elastomer, two-part 10:1 mix ratio, contains |
| sylgard.com) | dimethylvinylated and trimethylated silica |
| Zerogen 50 SP (J. M. Huber Corp., | Mg(OH)₂, vinyl silane-treated |
| hubermaterials.com) | |

### Torch and Grit Test

In the Torch and Grit Test (T&GT), each sample was mounted on an aluminum backing plate using mechanical clamps or adhesive tapes. The sample was then placed in a fixture which was slid horizontally in front of a Bethlehem Champion hydrogen torch (obtained from Bethlehem Apparatus Company Inc, of Hellertown, PA, USA) at a distance of 60 mm (2.375″) from the sample surface to the hydrogen torch face. The torch temperature was set at 1200° C., measured by a type K thermocouple 25.4 mm (1″) away from the torch face. A media blaster gun was loaded with 120 grit aluminum oxide non-shaped media and aligned with the center nozzle (nozzle 10 diameter=0.185″−0.188″) of the torch at the same distance (60 mm) from the sample. The media blaster gun was supplied with compressed air at 172 kPa (25 psi) and the flow was controlled to 50 LPM when triggered for a media blast.

A test includes a sample being moved into place and exposed to the torch flame for 5 seconds before the first media blast was initiated. One test cycle consists of one 10 second media blast (with torch flame) and one 10 second torch flame-only exposure for a total of a 20 second test cycle. The sample was exposed to 16 cycles, or the test was stopped when the sample material eroded away and the backing plate was exposed.

The T&GT is a modified version of the Torch and Grit Test described in WO 2021/144758 A1, incorporated by reference above.

Throughout the application, and in the Examples below, the terms “blasts” and “cycles” of the T&GT are used interchangeably. For example, if a sample survives 7 blasts of the T&GT, it survives 7 cycles of the T&GT, and vice versa.

### Thermal Insulation Flame Test

Specimens of size approximately 200×200 mm were painted black on one side with Flat Black Automotive High Heat Paint. The specimen was placed horizontally on a fixture with the painted surface on the top and the unpainted surface on the bottom surface, centered over a torch. The flame temperature at the point where the flame contacted the specimen was targeted at 1200° C., as measured by a thermocouple placed on the underside of the specimen in the flame. The lower surface of the specimen was exposed to the flame for 10 minutes while the top surface was left at ambient conditions (˜22° C.). The painted, top side of the specimen exposed to ambient conditions was measured by a stationary handheld IR thermometer (Westward model no. 54TZ30) every 30 seconds and videoed with a FLIR camera (Teledyne FLIR T440 Thermal Imaging Camera, Teledyne FLIR LLC, flir.com). The hottest temperature in the center of the specimen, as measured by the handheld IR thermometer, was recorded at 10 minutes.

### EXAMPLES

Comparative Example 1 (CE1): 9 layers of 3M™ Glass Cloth Electrical Tape 79 with Acrylic Adhesive were layered onto a 102×102 mm aluminum plate. Two CE1 specimens were made and were subjected to T&GT. Both specimens of Comparative Example 1 withstood or survived 4 cycles (or blasts) of the T&GT. During the 5th blast, the flame and particles reached the aluminum plate. During the Torch and Grit Test, burning of the acrylic adhesive was evident from large flames emanating from the surface and edges of the construction. Because the organic adhesive burned from the flame, virtually the entire area facing the flame and blast had blackened, and the remaining layers of glass cloth that did not get blasted through in the center portion of the blast had separated.

Comparative Example 2 (CE2): Sylgard 184 was cured at a thickness of 1.56 mm, trimmed into 102×102 mm squares, and mounted onto 102×102 mm aluminum plates with 3M™ Adhesive Transfer Tape 91022. Two Comparative Example 2 specimens were made and each survived 3 blasts of the T&GT. During the fourth blast, the flame and particles reached the aluminum plate.

Comparative Example 3 (CE3): One layer of 3M™ Glass Cloth Electrical Tape 69 with Silicone Adhesive was adhered to one face of a silicone foam substrate. A second layer of 3M™ Glass Cloth Electrical Tape 69 with Silicone Adhesive was adhered to the opposite face of the silicone foam substrate. Two of these 3.79 mm thick constructions were cut to 102×102 mm and adhered to 102×102 mm aluminum plates with 91022 silicone transfer tape. Both Comparative Example 3 specimens survived 3 blasts of the T&GT. During the fourth blast, the flame and particles reached the aluminum plate.

Comparative Example 4 (CE4): 12 layers of 0.14 mm e-glass cloth were laid on top of one another and laser cut to a 102×102 mm square to melt the edges together. This was tacked down to the four corners of a 102×102 mm aluminum plate with four drops of Sylgard 184.

The four drops of Sylgard 184 were far away from the specimen center where the Torch and Grit Test is focused, ensuring only glass cloth was in the test area. Two constructions were made in this manner, and both Comparative Examples 4_survived 6 blasts of the Torch and Grit Test; during the 7th blast, the flame and particles reached the aluminum panel.

Comparative Example 5 (CE5): A mixture of 55.0% Sylgard 184 and 45.0% KaMin 70 C was cured at a thickness of 1.49 mm, trimmed into 102×102 mm squares, and mounted onto 102×102 mm aluminum plates with 3M™ Adhesive Transfer Tape 91022. Two Comparative Example 5 specimens were made, surviving an average of 4.5 blasts of the T&GT.

Comparative Example 6 (CE6): A mixture of 30.7 weight percent AK 1000000, 2.3 weight percent DDCBP-50, and 67.0 weight percent Spheriglass 3000 was cured at a thickness of 1.57 mm, trimmed into a 102×102 mm square, and mounted onto a 102×102 mm aluminum plate with 3M™ Adhesive Transfer Tape 91022. One Comparative Example 6 specimen was made, surviving 4 blasts of the T&GT. During the fifth blast, the flame and particles reached the aluminum plate.

Comparative Example 7 (CE7): 8 layers of 3M 79 glass cloth electrical tape (acrylate adhesive) were adhered to one another, adhesive against glass cloth, to produce 16 total layers in an (approximate) 200×200 mm area. The resultant layered construction was bendable and flexible. This construction was tested with the Thermal Insulation Flame Test. After 10 minutes of being exposed to the flame, the ambient temperature side of the construction was 362° C., with a temperature delta of 838° C. vs. the 1200° C. torch side of the sample.

Example 1 (EX1): 9 layers of 3M™ Glass Cloth Electrical Tape 69 with Silicone Adhesive were layered onto a 102×102 mm aluminum plate. Averaged over two tests, this 1.45 mm thick construction survived 12 blasts of T&GT. During the T&GT, contrasted to Comparative Example 1 with an organic adhesive, there was only minor flaming of the silicone adhesive, and much more of the glass cloth retained its original white color after the test was completed.

Example 2 (EX2): A mixture of 55 weight percent Sylgard 184 and 45 weight percent KaMin 70 C was blended together. A bead of this mixture was laid cross-web on one end of a layer of 0.14 mm e-glass cloth and another layer of 0.14 mm e-glass cloth was placed on top. This construction was pulled through a notch bar nip to spread the Sylgard 184/KaMin 70 C mixture evenly between the glass cloth layers, then the construction was placed into an oven to cure the silicone. The result was a 1.50 mm thick alternating layered construction of glass cloth and Sylgard 184/KaMin 70 C. Two 102×102 mm sections were cut from this and laminated onto 102×102 mm aluminum plates with 91022 silicone transfer tape. Averaged over two tests, Example 2 survived 7 blasts of the T&GT.

Example 3 (EX3): A mixture of 52.4 weight percent AK 1000000, 2.6 weight percent DDCBP-50, and 45 weight percent Burgess KE was blended together. A bead of this mixture was laid cross-web on one end of a layer of 0.14 mm e-glass cloth and another layer of 0.14 mm e-glass cloth was placed on top. This construction was pulled through a notch bar nip to spread the filled silicone mixture evenly between the glass cloth layers, then the construction was placed into an oven to cure the silicone. The result was a 1.58 mm thick alternating layered construction of glass cloth and filled silicone. Two 102×102 mm sections were cut from this and laminated onto 102×102 mm aluminum plates with 91022 silicone transfer tape. Averaged over two tests, Example 3 survived an average of 10.5 blasts of the T&GT.

Example 4 (EX4): A mixture of 25.0 weight percent AK 1000000, 1.25 weight percent DDCBP-50, and 73.8 weight percent Spheriglass 3000 was blended together. A bead of this mixture was laid cross-web on one end of a layer of 0.14 mm e-glass cloth and another layer of 0.14 mm e-glass cloth was placed on top. This construction was pulled through a notch bar nip to spread the filled silicone mixture evenly between the glass cloth layers, then the construction was placed into an oven to cure the silicone. The result was a 1.52 mm thick alternating layered construction of glass cloth and filled silicone. Two 102×102 mm sections were cut from this and laminated onto 102×102 mm aluminum plates with 91022 silicone transfer tape. Averaged over two tests, Example 4 survived an average of 12 blasts of the T&GT.

Example 5 (EX5): A mixture of 32.4 weight percent AK 1000000, 1.6 weight percent DDCBP-50, 22.0 weight percent KaMin 70 C, and 44.0 weight percent Spheriglass 3000 was blended together. A bead of this mixture was laid cross-web on one end of a layer of 0.14 mm e-glass cloth and another layer of 0.14 mm e-glass cloth was placed on top. This construction was pulled through a notch bar nip to spread the filled silicone mixture evenly between the glass cloth layers, then the construction was placed into an oven to cure the silicone. The result was a 1.53 mm thick alternating layered construction of glass cloth and filled silicone. Two 102×102 mm sections were cut from this and laminated onto 102×102 mm aluminum plates with 91022 silicone transfer tape. Averaged over two tests, Example 5 survived an average of 11 blasts of the T&GT.

Example 6 (EX6): A mixture of 32.4 weight percent AK 1000000, 1.6 weight percent DDCBP-50, 22.0 weight percent Burgess KE, and 44.0 weight percent Spheriglass 3000 was blended together. A bead of this mixture was laid cross-web on one end of a layer of 0.14 mm e-glass cloth and another layer of 0.14 mm e-glass cloth was placed on top. This construction was pulled through a notch bar nip to spread the filled silicone mixture evenly between the glass cloth layers, then the construction was placed into an oven to cure the silicone. The result was a 1.56 mm thick alternating layered construction of glass cloth and filled silicone. Two 102×102 mm sections were cut from this and laminated onto 102×102 mm aluminum plates with 91022 silicone transfer tape. Averaged over two tests, Example 6 survived an average of 11.5 blasts of the T&GT.

Example 7 (EX7): A mixture of 90 weight percent Silopren 242-3 and 10 weight percent Satintone SP33 was blended together. A bead of this mixture was laid cross-web on one end of a layer of 0.14 mm e-glass cloth. Another layer of 0.14 mm e-glass cloth was placed on top of this construction. Another bead of the Silopren 242-3/Satintone SP33-mixture was placed on top of the second layer of glass cloth. This procedure was repeated until there were 6 layers of glass cloth interspersed with 5 layers of a bead of the Silopren 242-3/Satintone SP33 mixture. This construction was pulled through a notch bar nip to spread the Silopren 242-3/Satintone SP33 mixture evenly between the glass cloth layers, then the construction was placed into an oven to cure the silicone. The result was a 1.46 mm thick alternating layered construction of glass cloth and Silopren 242-3/Satintone SP33. Two 102×102 mm sections were cut from this and laminated onto 102×102 mm aluminum plates with 91022 silicone transfer tape. Averaged over two tests, Example 7 survived 7.5 blasts of the T&GT.

Example 8 (EX8): A mixture of 40 weight percent Sylgard 184 and 60 weight percent Mattex Pro was blended together. A bead of this mixture was laid cross-web on one end of a layer of 0.06 mm e-glass cloth and another layer of 0.06 mm e-glass cloth was placed on top. This construction was pulled through a notch bar nip to spread the Sylgard 184/Mattex Pro mixture evenly between the glass cloth layers, then the construction was placed into an oven to cure the silicone. The result was a 1.60 mm thick alternating layered construction of glass cloth and Sylgard 184/Mattex Pro. Two 102×102 mm sections were cut from this and laminated onto 102×102 mm aluminum plates with 91022 silicone transfer tape. Averaged over two tests, Example 8 survived 7.5 blasts of the T&GT.

Example 9 (EX9): A mixture of 47.2 weight percent Sylgard 184, 42.8 weight percent Suzorite 20S, and 10.0 weight percent Spheriglass 3000 was blended together. A bead of this mixture was laid cross-web on one end of a layer of 0.14 mm e-glass cloth. Another layer of 0.14 mm e-glass cloth was placed on top of this construction. Another bead of the Sylgard 184/Suzorite 20S/Spheriglass 3000 mixture was placed on top of the second layer of glass cloth, and a third layer of glass cloth was placed on top of this construction. This construction was pulled through a notch bar nip to spread the Sylgard 184/Suzorite 20S/Spheriglass 3000 mixture evenly between the glass cloth layers, then the construction was placed into an oven to cure the silicone. The result was a 1.64 mm thick alternating layered construction of glass cloth and Sylgard 184/Suzorite 20S/Spheriglass 3000. Two 102×102 mm sections were cut from this and laminated onto 102×102 mm aluminum plates with 91022 silicone transfer tape. Averaged over two tests, Example 9 survived 10 blasts of the T&GT.

Example 10 (EX10): A mixture of 55 weight percent Sylgard 184 and 45 weight percent KaMin 70 C was blended together. A bead of this mixture was laid cross-web on one end of a layer of 0.14 mm e-glass cloth. Another layer of 0.14 mm e-glass cloth was placed on top of this construction. Another bead of the Sylgard 184/KaMin 70 C mixture was placed on top of the second layer of glass cloth. This procedure was repeated until there were 8 layers of glass cloth interspersed with 7 layers of the Sylgard 184/KaMin 70 C mixture. This construction was pulled through a notch bar nip to spread the Sylgard 184/KaMin 70 C mixture evenly between the glass cloth layers, then the construction was placed into an oven to cure the silicone. The result was a 1.53 mm thick alternating layered construction of glass cloth and Sylgard 184/KaMin 70 C. Two 102×102 mm sections were cut from this and laminated onto 102×102 mm aluminum plates with 91022 silicone transfer tape. Averaged over two tests, Example 10 survived 7 blasts of the T&GT.

Example 11 (EX11): A mixture of 30.7 weight percent AK 1000000, 2.3 weight percent DDCBP-50, 60.0 weight percent Spheriglass 3000, and 7.0 weight percent KaMin 70 C was blended together. A bead of this mixture was laid cross-web on one end of a layer of 0.14 mm e-glass cloth and a layer of 0.14 mm e-glass cloth was placed on top. This construction was pulled through a notch bar nip to spread the filled silicone mixture evenly between the glass cloth layers, then the construction was placed into an oven to cure the silicone. The result was a 1.56 mm thick alternating layered construction of glass cloth and filled silicone. Two 102×102 mm sections were cut from this and laminated onto 102×102 mm aluminum plates with 91022 silicone transfer tape. Averaged over two tests, Example 11 survived an average of 10.5 blasts of the T&GT.

Example 12 (EX12): A mixture of 30.7 weight percent AK 1000000, 2.3 weight percent DDCBP-50, 60.0 weight percent Spheriglass 3000 CP-01, and 7.0 weight percent KaMin 70 C was blended together. A bead of this mixture was laid cross-web on one end of a layer of 0.14 mm e-glass cloth and a layer of 0.14 mm e-glass cloth was placed on top. This construction was pulled through a notch bar nip to spread the filled silicone mixture evenly between the glass cloth layers, then the construction was placed into an oven to cure the silicone. The result was a 1.54 mm thick alternating layered construction of glass cloth and filled silicone. Two 102×102 mm sections were cut from this and laminated onto 102×102 mm aluminum plates with 91022 silicone transfer tape. Averaged over two tests, Example 12 survived an average of 9 blasts of the T&GT.

Example 13 (EX13): A mixture of 46.5 weight percent AK 1000000, 3.5 weight percent DDCBP-50, and 50 weight percent Spheriglass 3000 was blended together. A bead of this mixture was laid cross-web on one end of a layer of 0.14 mm e-glass cloth and a layer of 0.61 mm e-glass cloth was placed on top. This construction was pulled through a notch bar nip to spread the filled silicone mixture evenly between the glass cloth layers, then the construction was placed into an oven to cure the silicone. The result was a 0.93 mm thick alternating layered construction of glass cloth and filled silicone. Two 102×102 mm sections were cut from this and laminated onto 102×102 mm aluminum plates with 91022 silicone transfer tape. Averaged over two tests, Example 13 survived an average of 13.5 blasts of the T&GT.

Example 14 (EX14): A mixture of 46.5 weight percent AK 1000000, 3.5 weight percent DDCBP-50, and 50 weight percent Spheriglass 3000 was blended together. A bead of this mixture was laid cross-web on one end of a layer of 0.61 mm e-glass cloth and another layer of 0.61 mm e-glass cloth was placed on top. This construction was pulled through a notch bar nip to spread the filled silicone mixture evenly between the glass cloth layers, then the construction was placed into an oven to cure the silicone. The result was a 1.98 mm thick alternating layered construction of glass cloth and filled silicone. Two 102×102 mm sections were cut from this and laminated onto 102×102 mm aluminum plates with 91022 silicone transfer tape. Averaged over two tests, Example 14 survived an average of 16 blasts of the T&GT.

Example 15 (EX15): A mixture of 24.4 weight percent AK 1000000, 1.8 weight percent DDCBP-50, 53.8 weight percent Spheriglass 3000, 10.0 weight percent FR CROS 486, and 10.0 weight percent Zerogen 50 SP was blended together. A bead of this mixture was laid cross-web on one end of a layer of 0.14 mm e-glass cloth and another layer of 0.14 mm e-glass cloth was placed on top. This construction was pulled through a notch bar nip to spread the filled silicone mixture evenly between the glass cloth layers, then the construction was placed into an oven to cure the silicone. The result was a 1.53 mm thick alternating layered construction of glass cloth and filled silicone. Two 102×102 mm sections were cut from this and laminated onto 102×102 mm aluminum plates with 91022 silicone transfer tape. Averaged over two tests, Example 15 survived an average of 9 blasts of the T&GT.

Example 16 (EX16): 8 layers of 3M 69 glass cloth electrical tape (silicone adhesive) were adhered to one another, adhesive against glass cloth, to produce 16 total layers in an (approximate) 200×200 mm area. The resultant layered construction was bendable and flexible. This construction was tested with the Thermal Insulation Flame Test. After 10 minutes of being exposed to the flame, the ambient temperature side of the construction was measured to be 263° C., with a temperature delta of 937° C. vs. the 1200° C. torch side of the sample. This construction may be suitable as a thermal barrier for applications requiring an ambient temperature side of 300° C. or less.

### Results

As samples can have different thicknesses, the results herein utilize a ratio parameter, where, for a given sample, the number of T&GT blasts survived or withstood is divided by the sample thickness. Table 2 below shows several T&GT blasts survived/thickness ratios for Comparative Examples 1 through 6. Comparative Example 2 (a slab of crosslinked silicone) and Comparative Example 3 (a multilayer construction with glass cloth, adhesive, and silicone foam) both survived 3 T&GT blasts. However, since Comparative Example 3 is over twice the thickness of Comparative Example 2, its efficiency at withstanding the T&GT blasts is much less; this property is indicated in the final column, with the ratio parameter of CE2 being 1.9 vs. CE 3 with a value of only 0.8. The Comparative Example constructions all have relatively low T&GT blasts survived/thickness ratios as compared to the values shown further below in Table 3.

TABLE 2
Comparative Examples 1-6 showing sample thickness, number of Torch and Grit
Test blasts survived, and the ratio number of T&GT blasts survived/thickness.

| | | | Average | |
|---|---|---|---|---|
| | | | No. of | No. T&GT |
| | | | T&GT | Blasts Survived/ |
| | | Thickness | Blasts | Thickness |
| Example | Construction | (mm) | Survived | (No./mm) |
| CE1 | 9 Layers 3M ™ Glass Cloth Electrical Tape 79 | 1.54 | 4 | 2.6 |
| CE2 | Sylgard 184 | 1.56 | 3 | 1.9 |
| CE3 | 69 Tape + Silicone Foam + 69 Tape | 3.79 | 3 | 0.8 |
| CE4 | 12 layers e-glass cloth | 1.44 | 6 | 4.2 |
| CE5 | 55% Sylgard 184 + 45% KaMin 70 C. | 1.49 | 4.5 | 3.0 |
| CE6 | 67.0% Spheriglass 3000 + 30.7% AK 1000000 + | 1.57 | 4 | 2.5 |
| | 2.3% DDCBP-50 | | | |

Table 3 provides the compositions, thicknesses, number of Torch and Grit Test blasts survived, and the T&GT blasts survived/thickness ratios for Examples 1-15. The total thicknesses for all of these constructions are below 2 mm. The resulting T&GT blasts survived/thickness ratio for this wide range of compositions and number of layers is at least 4.6 for these examples, illustrating that a variety of relatively thin constructions comprising core layers and binder layers can provide suitable barrier properties against a high temperature blast.

TABLE 3
Compositions and Torch and Grit Test results for Examples 1-15.

| | | | | | | No. |
|---|---|---|---|---|---|---|
| | | | | | | T&GT |
| | | | | | Average | Blasts |
| | No. of | No. of | | | No. of | Survived/ |
| | glass | silicone | | | T&GT | Thickness |
| | cloth | blend | | Thickness | Blasts | (No./ |
| Example | layers | layers* | Filler | (mm) | Survived | mm) |
| EX1 | 9 | 9 | MQ Resin | 1.45 | 12.0 | 8.3 |
| EX2 | 2 | 1 | 45% Kamin 70 C. + dimethylvinylated | 1.50 | 7.0 | 4.7 |
| | | | and trimethylated silica | | | |
| EX3 | 2 | 1 | 45% Burgess KE | 1.58 | 10.5 | 6.6 |
| EX4 | 2 | 1 | 73.8% Spheriglass 3000 | 1.52 | 12.0 | 7.9 |
| EX5 | 2 | 1 | 44% Spheriglass 3000 + 22% Kamin | 1.53 | 11.0 | 7.2 |
| EX6 | 2 | 1 | 44% Spheriglass 3000 + 22% Burgess | 1.56 | 11.5 | 7.4 |
| | | | KE | | | |
| EX7 | 6 | 5 | 10% Satintone SP33 + fumed silica | 1.46 | 7.5 | 5.1 |
| EX8 | 2 | 1 | 60% Mattex Pro + dimethylvinylated | 1.60 | 7.5 | 4.7 |
| | | | and trimethylated silica | | | |
| EX9 | 3 | 2 | 42.8% Suzorite 20-S + 10% | 1.64 | 10.0 | 6.1 |
| | | | Spheriglass 3000 + dimethylvinylated | | | |
| | | | and trimethylated silica | | | |
| EX10 | 8 | 7 | 45% Kamin 70 C. + dimethylvinylated | 1.53 | 7.0 | 4.6 |
| | | | and trimethylated silica | | | |
| EX11 | 2 | 1 | 60% Spheriglass 3000 + 7% | 1.56 | 10.5 | 6.7 |
| | | | KaMin 70 C. | | | |
| EX12 | 2 | 1 | 60% Spheriglass 3000 CP-01 + 7% | 1.54 | 9.0 | 5.8 |
| | | | KaMin 70 C. | | | |
| EX13 | 2 | 1 | 50.0% Spheriglass 3000 | 0.93 | 13.5 | 14.5 |
| EX14 | 2 | 1 | 50.0% Spheriglass 3000 | 1.98 | 16.0 | 8.1 |
| EX15 | 2 | 1 | 53.8% Spheriglass 3000 + 10.0% FR | 1.53 | 9.0 | 5.9 |
| | | | CROS 486 + 10.0% Zerogen 50 SP | | | |

*The number of silicone blend layers and thickness shown excludes a thin 91022 transfer adhesive that is used to bond the samples to the aluminum plate (except for EX1 which already has a silicone adhesive)

As evidenced in Table 3, use of the number of T&GT blasts survived/thickness ratio can help an investigator identify suitable barrier article constructions for space-constrained applications. Higher values of this ratio provide a good indication of the suitability of a particular construction in a space-constrained application such as an electric vehicle battery pack. Although a particular construction may have an exceptionally high blast/thickness ratio, other considerations such as thermal insulation, cost, dielectric strength, or other relevant properties may favor a construction with a slightly lower blast/thickness ratio.

CE2, CE5, and CE6 are monolithic slabs of a binder layer comprising silicone with different fillers; each of these Comparative Examples has a number of T&GT blasts survived/thickness ratio that is 3.0 or less. Comparative Example 4, comprising multilayers of only glass cloth, has a number of T&GT blasts survived/thickness ratio of 4.2. The highest number of T&GT blasts survived/thickness ratio for all Comparative Examples is 4.2. The lowest number of T&GT blasts survived/thickness ratio for the Examples described herein is 4.6. This demonstrates the synergistic properties of multilayer constructions comprising core layers and filled silicone binder layers. This layered system has a blast resistance that is greater than would be expected for the individual components.

The results of Table 3 illustrate that all of the systems with both core layers and binder layers withstand the T&GT better than the Comparative Examples. The systems comprising both core layers and binder layers have excellent resistance to a high temperature flame and a grit blast, demonstrating their usefulness as a protective layer in EV battery systems. The number of core layers in these Examples ranged from 2 to 9, more core layers could be possible.

The thicknesses of the core layers ranged from 0.05 mm to 0.61, and it was demonstrated that more than one core thickness could be used in a construction. The amount of added filler in the silicone binder layer ranged from 10 to 73.8%, though more could be added, such as by utilizing a bimodal or trimodal distribution of filler sizes. The number of types of inorganic fillers within a single binder layer ranged from 1 to 3, though more could be added for additional properties.

In the Thermal Insulation Flame Test, the ambient temperature side of Comparative Example 7 with the acrylic adhesive was shown to increase to 362° C. after 10 minutes of exposure to the 1200° C. flame. The ambient temperature side of Example EX16 was only 263° C., demonstrating that this multilayer construction with filled silicone can provide better insulation than a multilayer construction with acrylic adhesive. The alternating construction of filled silicone binder and core layers can therefore provide better blast resistance (CE1 vs. EX1) and better thermal insulation properties.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A thermal barrier article comprising:
a plurality of core layers, wherein at least one core layer includes a woven or nonwoven fiber mat or fabric; and
a plurality of binder layers, wherein at least one binder layer includes a filled silicone material, wherein the plurality of core layers and binder layers are arranged in an alternating manner, and
wherein the thermal barrier article has a ratio of T&GT blasts withstood divided by sample thickness of at least 4.4 blast cycles/mm.

2. The thermal barrier article of claim 1, wherein the woven or nonwoven fiber mat or fabric comprises a plurality of inorganic fibers.

3. The thermal barrier article of claim 1, wherein the woven or nonwoven fiber mat or fabric comprises a plurality of fibers selected from the group consisting of A-glass, C-glass, D-glass, E-glass, M-glass, R-glass, S-glass, ECR-glass, AR-glass, basalt fibers, silicate fibers (e.g. Astroquartz fibers), silicon carbide fibers, ceramic fibers (e.g. Nextel fibers), or combinations thereof.

4. (canceled)

5. The thermal barrier article of claim 1, wherein the filled silicone material further comprises solid glass particles.

6. The thermal barrier article of claim 1, wherein the thermal barrier article has a thickness in the range of from about 0.5 mm to about 10.0 mm.

7. (canceled)

8. The thermal barrier article of claim 1, wherein each of the plurality of core layers comprises the same material.

9. The thermal barrier article of claim 1, wherein at least two of the plurality of core layers comprise different materials.

10. The thermal barrier article of claim 1, wherein at least two of the plurality of binder layers comprise different materials.

11. (canceled)

12. The thermal barrier article of claim 1, wherein each core layer comprises a thickness from about 0.04 mm to about 1 mm.

13. (canceled)

14. The thermal barrier article of claim 1, wherein the filled silicone material comprises inorganic clays and minerals at least one binder layer comprises a solid glass particle filler material.

15. The thermal barrier article of claim 1, wherein the solid glass particle filler material has an average size of about 10 microns to about 100 microns.

16. The thermal barrier article of claim 1, wherein the thermal barrier article has a ratio of T&GT blasts withstood divided by sample thickness of at least 4.4 is operatively adapted to survive or withstand at least 7 blast cycles of the torch and grit test.

17. The thermal barrier article of claim 1, wherein the thermal barrier article is operatively adapted to have a ratio of T&GT blasts withstood divided by sample thickness of at least 6.5 blast cycles/mm.

18. The thermal barrier article of claim 1, wherein the barrier article is flexible such that it can bend at least 0.5% in a 3-point bend test (per ASTM D790) before failing.

19. A battery compartment of an electric vehicle comprising at least one battery cell or assembly, wherein the thermal barrier article of claim 1 is disposed between the at least one battery cell or assembly and a lid.

20. A method of preventing or at least mitigating the further spread of blast debris in or from an electric vehicle battery assembly, with the method comprising:
at least partially enclosing at least one battery cell or module of an electric vehicle battery assembly with the thermal barrier article of claim 1.

21. Use of a barrier article as a thermal insulation and blast protection barrier in a rechargeable electrical energy storage system, the barrier article comprising the thermal barrier material of claim 1.

22-35. (canceled)

36. The thermal barrier article of claim 1, wherein each binder layer comprises from about 7 to about 60 weight percent inorganic clays and minerals.

37. The thermal barrier article of claim 36, wherein each binder layer comprises from about 40 to about 55 weight percent inorganic clays and minerals.

38. A thermal barrier article comprising:
a plurality of core layers, wherein at least one core layer includes a woven or nonwoven fiber mat or fabric, wherein at least one of the core layers includes an outer surface;
at least one binder layer, wherein the at least one binder layer includes a filled silicone material: and
an adhesive layer disposed on the at least one outer surface of the at least one core layer,
wherein the thermal barrier article has a ratio of T&GT blasts withstood divided by sample thickness of at least 4.4 blast cycles/mm.
